(19) United States
(12) Patent Application Publication
(10) Pub. No.: US 2007/0086718 A1
(43) Pub. Date: Apr. 19, 2007

(54) Optical element and manufacturing method thereof

(75) Inventors: Tsuyoshi Aoki, Kawasaki (JP); Masao Kondo, Kawasaki (JP); Kazuaki Kurihara, Kawasaki (JP); Makoto Kuwabara, Fukuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/343,232

(22) Filed: Jan. 31, 2006

(30) Foreign Application Priority Data
Oct. 14, 2005 (JP) 2005-300526

(51) Int. Cl. G02B 6/10

(52) U.S. Cl. 385/132; 385/122

(57) ABSTRACT

An optical element is constituted by providing an optical waveguide formed with a piezoelectric material, a photonic crystal structure provided within the optical waveguide, a pair of control electrodes, which are provided so as to sandwich the upper and lower surfaces of the optical waveguide, for applying a voltage to the optical waveguide and supporting parts formed at the both ends of the lower control electrode.

### CROSS-REFERENCE TO RELATED APPLICATIONS

This application is based upon and claims the benefit of priority from the prior Japanese Patent Application No. 2005-300526, filed on Oct. 14, 2005, the entire contents of which are incorporated herein by reference.

### BACKGROUND OF THE INVENTION

1. Field of the Invention

The present invention relates to an optical element that selectively transmits light of a desired wavelength.

2. Description of the Related Art

Recently, there has been proposed a new artificial crystal called as “photonic crystal” in which substances each having a different refractive index are periodically arranged at intervals of wavelength or so, and the photonic crystal attracts attention. This artificial crystal has unique optical characteristics such as forbidden existence of light having a certain wavelength (photonic band gap) caused by so-called photonic band structure, which is similar to the band structure of semiconductor, and large optical deflection (super prism effect). Since, these characteristics can be artificially designed in structure and scale, the artificial crystal is now under a vigorous research and development as an optical element. As one of the research and developments drawing attention, an active optical element is cited. This element is an element of which optical characteristics can be actively controlled from the outside not only in its designing but also during its use, and is expected to apply to wide range of field such as a variable filter and an optical switch.

As specific examples of conventional art for modulating transmission wavelength by use of the photonic crystal, for example, the arts disclosed in the following Patent documents 1 to 3 can be cited.

Patent document 1 (Japanese Patent Application Laid-open No. 2004-145315) has disclosed a composition in which a cylindrical member forming a photonic crystal is deformed by the force applied to the cylindrical member in the direction perpendicular to the arrangement direction using an actuator to change a periodic structure of the photonic crystal.

Patent document 2 (Japanese Patent Application Laid-open No. 2003-101138) has disclosed a composition in which a mirror (periodic structure) is caused to undergo lattice deformation using a spring formed on a substrate.

Patent document 3 (Japanese Patent Application Laid-open No. 2001-91911) has disclosed a composition in which a primary periodic structure formed by laminating SiO₂/TiO₂ as a unit into a multi-layer structure is interposed by a thin PZT layer sandwiched with a pair of ITO layers, and the thickness of the PZT layer is changed by applying a voltage to the pair of ITO layers.

However, the above conventional arts have the following problems.

In the patent document 1, due to a mechanical structure using the actuator, the device structure becomes complicated and large in size. Further, since the optical element is restricted by the substrate, the deformation of the photonic crystal is not isotropic, and the photonic crystal does not change periodically, a small modulation is obtained.

In the patent document 2 likewise, since a mechanical structure using an actuator and the spring is employed, the device structure becomes complicated and large in size. Further, since the optical element is restricted by the substrate, a small modulation is obtained.

In the patent document 3, only the thin PZT layer is changed in thickness by an applied voltage. Since the variation of the thickness is small, a large modulation is not obtained.

In these days, miniaturization and high performance are required for the optical elements for modulating the transmission wavelength. An optical element capable of obtaining a large transmission wavelength modulation without requiring a large-scale and complicated device is now sought.

### SUMMARY OF THE INVENTION

An object of the present invention is to provide a highly-reliable and widely-applicable optical element capable of obtaining a large transmission wavelength modulation with an extremely simple and minute structure by use of a photonic crystal.

The optical element of the present invention includes: a film-like optical waveguide formed with a piezoelectric material; a photonic crystal structure provided in a predetermined area inside the optical waveguide, in which a plurality of structural bodies formed with a material having the refractive index different from that of the optical waveguide is periodically arranged; and a pair of control electrodes, which are provided at the part including at least the predetermined area of the optical waveguide, for applying a voltage to the optical waveguide, wherein the pair of control electrodes is in an unfixed state at least in connection with its part corresponding to the predetermined area.

A manufacturing method of an optical element of the present invention includes the steps of: forming an optical waveguide by laminating a clad layer, a core layer and a clad layer in this order on a substrate via a lower control electrode; forming a photonic crystal structure, in which a plurality of structural bodies formed with a material having the refractive index different from that of the optical waveguide is periodically arranged in a predetermined area; forming an upper control electrode on the photonic crystal structure; and putting a part of the respective control electrodes corresponding to the predetermined area in an unfixed state.

### BRIEF DESCRIPTION OF THE DRAWINGS

FIGS. 1A and 1B are schematic views showing a principal configuration of an optical element according to the present embodiment;

FIGS. 2A and 2B are schematic plan views for illustrating a mechanism of transmission wavelength modulation by use of an optical element 10 according to the embodiment;

FIG. 3 is a diagram showing characteristics of photonic band structure drawn by optical simulation;

FIGS. 4A and 4B are schematic views showing a lattice arrangement of a photonic band structure;

FIGS. 5A to 5E are schematic views showing a manufacturing method of the principal configuration of the optical element according to the present embodiment on the basis of manufacturing sequence; and

FIGS. 6A to 6C are schematic views continuing FIGS. 5A to 5E showing a manufacturing method of the principal configuration of the optical element according to the present embodiment on the basis of manufacturing sequence.

### DETAILED DESCRIPTION OF THE PREFERRED EMBODIMENTS

Basic Gist of the Present Invention

In the present invention, in order to constitute an optical element in a simple and minute structure, a film-like optical waveguide, in which the core layer is sandwiched by the clad layers at the top and bottom thereof, is used. As the material for the optical element, a piezoelectric material is used. Provided in a predetermined area of the optical waveguide is a photonic crystal structure, in which a plurality of structural bodies formed with a material having the refractive index different from that of the optical waveguide is periodically arranged. In a part, which includes at least a predetermined area of the optical waveguide, a pair of control electrodes is provided. Here, the optical waveguide is used in a state that the optical waveguide including the pair of control electrodes is used in a state of substantially self-supporting film, that is, in a state that the respective control electrodes located in the parts corresponding to the predetermined area, are not fixed, in consideration of changing the film thickness of the optical waveguide without being restricted by the substrate or the like.

When a voltage is applied from the pair of control electrodes to the optical waveguide, the film thickness of the optical waveguide in the predetermined area varies due to the piezoelectric effect in accordance with the voltage value. Due to the variation of the film thickness, the periodic structure of the structural bodies is changed, and the photonic band structure of the photonic crystal structure varies, thus the transmission wavelength varies accordingly. Therefore, by controlling the voltage applied from the pair of control electrodes to the optical waveguide, the wavelength of the light in the optical waveguide can be controlled. Here, since the optical waveguide is formed in a state of substantially self-supporting film, the optical waveguide is free from restriction by the substrate or the like. And since the entirety of the optical waveguide is formed with a piezoelectric material, even when the optical waveguide is formed extremely thin, a large variation of the film thickness can be obtained, and thereby a large transmission wavelength modulation can be obtained.

Specific Embodiments to which the Present Invention is Applied

(First Embodiment)

In the present embodiment, specific constitution of an optical element to which the present invention is applied will be disclosed.

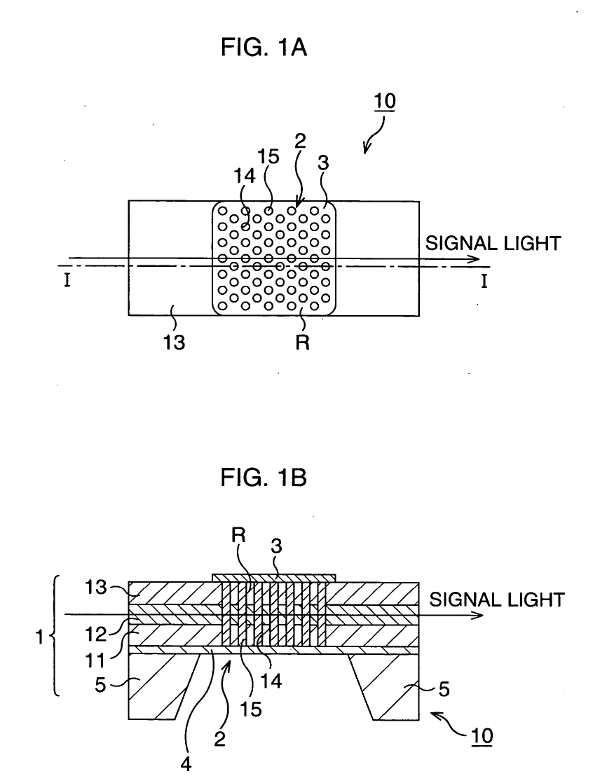

FIGS. 1A and 1B show a principal structure of the optical element according to the embodiment; FIG. 1A is a schematic plan view thereof and FIG. 1B is a schematic sectional view taken along a chain line I-I in FIG. 1A.

As shown in FIGS. 1A and 1B, an optical element 10 according to the present embodiment includes: an optical waveguide 1 formed with a piezoelectric material; a photonic crystal structure 2 provided in a predetermined area R through which signal light in the optical waveguide 1 passes; a pair of control electrodes 3 and 4 provided so as to sandwich the upper and lower surfaces of at least predetermined area R in the optical waveguide 1 for applying a voltage to the optical waveguide 1; and supporting parts 5 formed at the both ends of the lower control electrode 4.

The optical waveguide 1 is a slab type waveguide with a core layer 12, in which a light path is formed, sandwiched between a lower clad layer 11 and an upper clad layer 13. As for the piezoelectric material for the optical waveguide 1, a material having a large piezoelectric effect is preferably used. Here, a ferroelectric material having also an electro-optical effect (an effect that refractive index varies when a voltage is applied) is preferred. Therefore, (Pb, La) (Zr, Ti)O₃(PLZT) and the like are usable, since they have not only the electro-optical effect but also the piezoelectric effect. However, a material having a larger piezoelectric effect, for example, a material selected from the group of (1-x)Pb(Mg_{1/3}Nb_{2/3})O₃-xPbTiO₃(PMN-PT), (1-x)Pb(Zn_{1/3}Nb_{2/3})O₃-xPbTiO₃(PZN-PT) and (1-X)Pb(Ni_{1/3}Nb_{2/3})O₃-xPbTiO₃(PNN-PT) is used. The above described three materials having a large piezoelectric effect are solid solution and have such characteristics that the larger is a value “x”, the larger is a refractive index.

The photonic crystal structure 2 is constituted of a photonic crystal in which a plurality of structural bodies, which are formed with a material having the refractive index different from that of the optical waveguide 1, are periodically arranged. Here, in the predetermined area R, a plurality of through holes 14 are formed. These through holes 14 are filled with a material having the refractive index different from that of the piezoelectric material of the optical waveguide 1; in this embodiment, the material is a transparent resin; and thus, the respective structural bodies 15 with a columnar shape are formed. Two kinds of substances composed of the structural bodies 15 and piezoelectric materials around the structural bodies 15 are periodically arranged. In this case, the periodic structure, i.e., the size, shape and arrangement period of the through holes 14 are appropriately adjusted so that a predetermined photonic band structure with no voltage applied can be obtained. By using the transparent resin as a filler for the through holes 14, as compared to the case where the structural bodies are formed with the through holes 14 which are formed as cavities without using any filler (the case where the air is used as the filler), the withstand voltage performance is improved to allow prevention of discharge. As for the filler, any material having the refractive index different from that of the piezoelectric material of the optical waveguide 1 may be employed. For example, silica or the like may be preferably used.

The pair of control electrodes 3 and 4 is provided respectively in such a manner that the upper control electrode 3 is formed so as to cover the upper surface of the predetermined area R which is the part forming the photonic crystal structure 2 of the optical waveguide 1, and the lower control electrode 4 is formed so as to cover the entire lower surface of the optical waveguide 1. By controlling the voltage applied to the predetermined area R of the optical waveguide 1 from the control electrodes 3 and 4, the photonic band structure of the photonic crystal structure 2 is varied, and thereby the wavelength band of the signal light transmitted through the optical waveguide 1 can be selectively controlled.

The supporting part 5 is formed with, for example, silicon as the material, and is provided to support the both ends of the lower control electrode 4. Owing to the supporting part 5, the predetermined area R, i.e., the part of the photonic crystal structure 2 of the optical waveguide 1 is formed in an unfixed state (more particularly, the part corresponding to the predetermined area R of the control electrodes 3 and 4 is formed in an unfixed state. Owing to this structure, substantially an unfixed state is obtained in the part where the photonic crystal structure 2 of the optical waveguide 1 is formed). Thereby, when a voltage is applied by the control electrodes 3 and 4, a large film thickness variation of the optical waveguide 1 is obtained without being restricted by the substrate or the like.

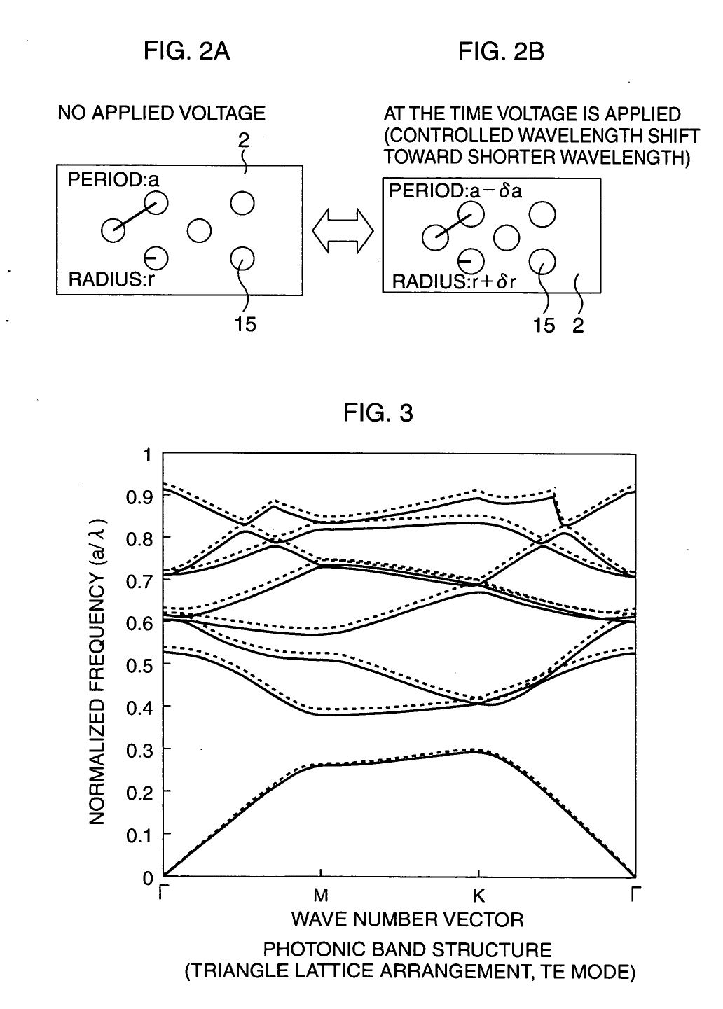

Here, mechanism of the transmission wavelength modulation by use of the optical element 10 according to the present embodiment will be described with reference to FIGS. 2A and 2B.

FIG. 2A shows the state of the photonic crystal structure 2 to which no voltage is applied. In this state, it is assumed that radius of each of the structural bodies 15 is “r”; and period thereof is “a”. When a voltage is applied through the control electrodes 3 and 4, the optical waveguide 1 is elongated in the thickness direction due to the piezoelectric effect. Owing to the elongation of the optical waveguide 1, as shown in FIG. 2B, each of the structural bodies 15 of the photonic crystal structure 2 receives a tensile force in the elongation direction of the radius, and the radius is expanded to r+δr; and the period is reduced to a−δa. Owing to the variation of the periodic structure, the photonic band structure varies and the wavelength of the transmitted light shifts toward the shorter wavelength. That is, by applying the voltage as described above, the wavelength band of the signal light transmitting through the optical waveguide 1 is modulated.

On the basis of the above-described mechanism, a result of the optical simulation, which was conducted using the optical element 10 with the above described constitution, will be described. FIG. 3 is a diagram showing the characteristics of the photonic band structure plotted based on the optical simulation.

Here, assuming that the ratio of radius: period is, for example, 0.33; plane wave development method was used. As an example of the photonic band structure shown in FIG. 3, the calculation was made based on TE mode, which is the state of polarization in which electric field component of the light is parallel with respect to the substrate.

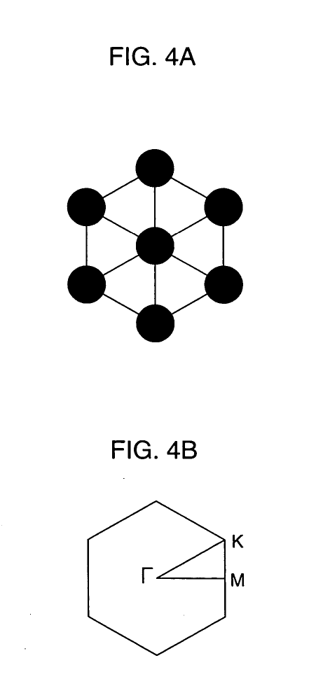

As the lattice arrangement of the photonic band structure, assuming a triangle lattice arrangement shown in FIG. 4A, the black circles disposed in hexagonal shape are the parts where the refractive index is low, and the area other than the black circles indicates the material of the optical waveguide. In the case of such arrangement, the reciprocal lattice space is as shown in FIG. 4B. The triangle formed by points Γ, M and K connected to each other with a line having a high symmetric property (which are frequently used in band structure of semiconductor) is the minimum unit within the reciprocal lattice space, which is called as irreducible Brillouin zone. The horizontal axis in FIG. 3 indicates wave number vector along the above-described points Γ, M and K. The vertical axis indicates a frequency normalized by the period of the periodic structure (in this case, an edge of the triangle shown in FIG. 4A). The characteristic numbers of the light frequency for each wave number vector are plotted and connected to each other to provide a photonic band structure.

In FIG. 3, the solid line indicates the photonic band structure when no electric field is applied, and the dotted line indicates the photonic band structure when an electric field is applied, respectively. Assumed is a state, in which, when an electric field is applied, the optical waveguide deforms by 1% in the direction perpendicular to the thickness direction (or in the period direction) thereof. As to what level the actual wavelength can be controlled, for example, when signal light of TE mode enters in the Γ-M direction, with respect to the photonic band structure connecting Γ-M, it is determined that no photonic band exists in a frequency band of 0.26-0.38 on the solid line. This is a forbidden band of light called photonic band gap (PBG). The light within this frequency band can not exist in the optical waveguide 1.

As shown in the following table 1, for example, when setting the light of a communication band wavelength (1550 nm) to the lower end of the PBG, the period of the photonic band structure has to be set to 405 nm. The region of the PBG formed by the photonic crystal whose period is 405 nm becomes, due to 1550×0.261392 and 1550 nm×0.380004, approximately 1065 nm-1550 nm. Assuming that the period is reduced by 1% to 401 nm as a result of the application of the voltage, the zone of PBG formed by the photonic crystal whose period is 401 nm becomes approximately 1025 nm-1511 nm. Accordingly, in this case, wavelength band control of approximately 30 nm-40 nm or so is possible.

TABLE 1

| | | No-voltage | | Voltage |
|---|---|---|---|---|
| | No-voltage | applied | Voltage | applied |
| | applied | wavelength | applied | wavelength |
| | frequency | (nm) | frequency | (nm) |
| PBG lower end | 0.261392 | 1549.397074 | 0.265423 | 1510.795975 |
| PBG upper end | 0.380004 | 1065.778255 | 0.391393 | 1024.545661 |

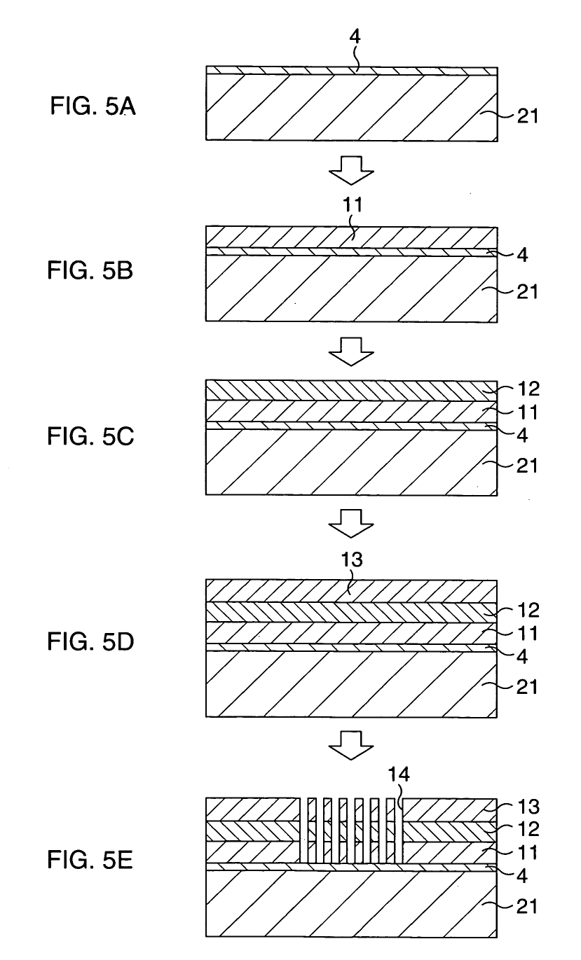

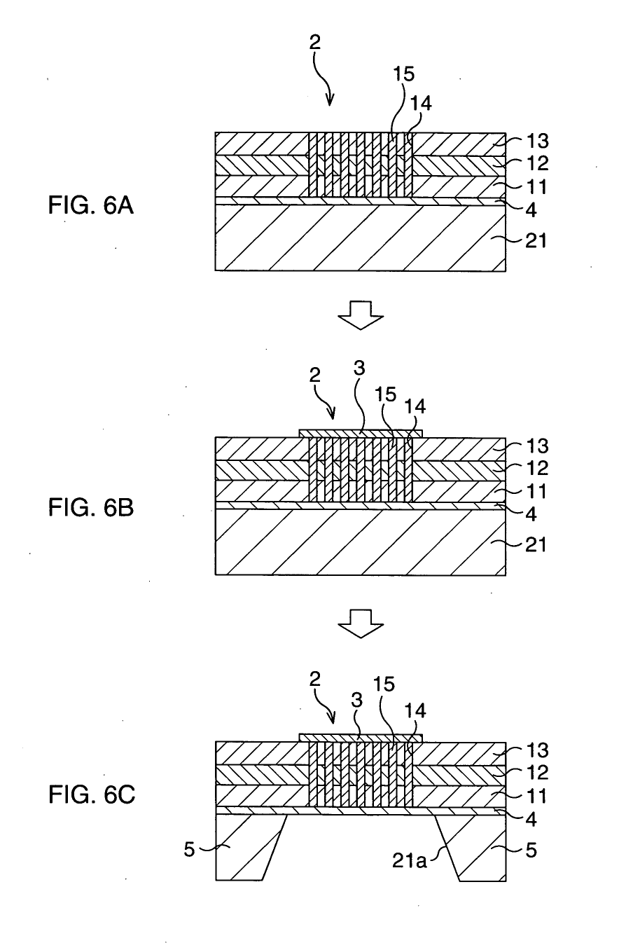

Next, a manufacturing method of the optical element 10 according to the present embodiment will be described with reference to FIGS. 5A to 5E and FIGS. 6A to 6C.

First, as shown in FIG. 5A, the lower control electrode 4 is formed on a silicon substrate 21.

Specifically, on the silicon substrate 21, for example, by using sputtering method, a conductive oxide film such as SrRuO₃ and IrO₂, or a metal film such as Pt and Ir is deposited to a film thickness of 200 nm or so to form the lower control electrode 4.

Succeedingly, as shown in FIG. 5B, the lower clad layer 11 is formed on the lower control electrode 4.

Specifically, the lower clad layer 11 is formed by means of sol-gel process so that, for example, “x” becomes x=0.24, while using for example, PMN-PT out of the (1-x)Pb(Mg_{1/3}Nb_{2/3})O₃-xPbTiO₃(PMN-PT), (1-x)Pb(Zn_{1/3}Nb_{2/3})O₃-xPbTiO₃(PZN-PT), and (1-x)Pb(Ni_{1/3}Nb_{2/3})O₃-xPbTiO₃(PNN-PT). In this case, the film thickness of the lower clad layer 11 can be controlled in such a way that a precursor solution of PMN-PT is applied several times on the lower control electrode 4 by use of dip method or spin coat method. Here, the lower clad layer 11 of 2 μm or so in film thickness is formed.

Succeedingly, as shown in FIG. 5C, the core layer 12 is formed on the lower clad layer 11 with a laminated layer.

Specifically, using the PMN-PT, the core layer 12 is formed on the lower clad layer 11 by means of sol-gel process so that, for example, “x” becomes x=0.38. In this case also, like the case of forming the lower clad layer 11, by performing applications several times on the lower clad layer 11 by use of dip method or spin coat method, the film thickness of the core layer 12 can be controlled. Here, the core layer 12 is formed to 3 μm or so in film thickness.

Succeedingly, as shown in FIG. 5D, the upper clad layer 13 is formed on the core layer 12 with a laminated layer.

Specifically, like the case of forming the lower clad layer 11, using the PMN-PT, the upper clad layer 13 is formed on the core layer 12 by means of sol-gel process so that, for example, “x” becomes x=0.38. In this case also, by performing applications several times on the core layer 12 by use of dip method or spin coat method, the film thickness of the upper clad layer 13 can be controlled. Here, the upper clad layer 13 is formed to 2 μm or so in film thickness.

Thus, the optical waveguide 1 having the structure in which the upper and lower surfaces of the core layer 12 are sandwiched by the upper clad layer 13 and the lower clad layer 11 is completed.

When forming the lower clad layer 11, the core layer 12 and the upper clad layer 13, instead of the sol-gel process, sputtering method, laser deposition method, MOCVD method, or the like may be employed.

Succeedingly, as shown in FIG. 5E, formed is a plurality of patterns of the through holes 14 of the photonic crystal structure 2 in a predetermined area of the optical waveguide 1.

Specifically, first, for example, an electron beam resist (not shown) is applied on the optical waveguide 1, and the patterns of the respective through holes 14 are formed in the predetermined part of the electron beam resist by means of direct drawing with electron beam, development or the like. Next, using the electron beam resist as a mask, by means of dry etching by use of an etching gas such as Ar, Cl₂ and BCl₃, the optical waveguide 1 is subjected to etching until the surface of the lower control electrode 4 is exposed. Owing to this etching, in the optical waveguide 1, the through holes 14 are formed in accordance with the pattern of the electron beam resist. Then, the electron beam resist is removed by means of ashing process or the like.

Succeedingly, as shown in FIG. 6A, by filling the through holes 14 with a transparent resin, the structural bodies 15 are formed.

Specifically, as for the transparent resin, any resin that is transparent in the wavelength band of light may be employed. For example, fluorinated polymer is filled by means of dip method. The structural bodies shown in FIG. 5E are dipped in a fluorinated polymer solution and, after degassing by means of ultrasonic or vacuum, taken out therefrom. By means of the above dip method, the structural bodies 15 with the through holes 14 filled with the transparent resin are formed, and thus the photonic crystal structure 2 constituted of the plurality of structural bodies 15 is completed. Incidentally, the usable transparent resin is not limited to the fluorinated polymer, but may be an acrylic resin or the like. Also, the filling method of the through hole 14 is not limited to the dip method, but may be preferably a spin coat method when the viscosity of the solution is low and filling is possible.

Succeedingly, as shown in FIG. 6B, on the optical waveguide 1, the upper control electrode 3 is formed using a pattern.

Specifically, for example, an electron beam resist (not shown) is applied on the optical waveguide 1, and a pattern of the upper control electrode 3 is formed with the pattern opened by means of the direct drawing of the electron beam, development and the like at the part corresponding to the predetermined area R of the electron beam resist. Succeedingly, a conductive oxide film such as SrRuO₃, IrO₂ or a metal film such as Pt, Ir is deposited on the entire surface by means of sputtering method. At this time, the conductive oxide film or metal film is deposited on the optical waveguide 1 only in the part exposed by the patterning, with the electron beam resist as the mask. Then, by means of lift off method, the electron beam resist and the conductive oxide film or the metal film on the electron oxide resist are removed to perform the pattern forming of the upper control electrode 3.

Succeedingly, as shown in FIG. 6C, formed is the supporting part 5 by processing the silicon substrate 21.

Specifically, as the etchant, for example, using a KOH solution, anisotropic wet etching is made to expose the part corresponding to the predetermined area R of the lower control electrode 4, and the silicon of the part is removed to form space 21a. Owing to the anisotropic wet etching, the supporting part 5 having a shape supporting the both ends of the lower control electrode 4 is formed.

By carrying out the above processes and various later processing, the optical element 10 of the present embodiment is completed.

Incidentally, in the above description, that the optical element of the present invention is used for modulating the transmission wavelength is exemplified. However, the application of the optical element is not limited to the above. As described above, since PMN-PT, PZN-PT and PNN-PT have not only a large piezoelectric effect but also an electro-optical effect, in addition to the transmission wavelength modulation, by utilizing a super prism effect of the photonic crystal structure 2, the optical element of the present invention may be used as an optical deflection element.

As described above, according to the present embodiment, a highly-reliable and widely-applicable optical element 10 having an extremely simple and minute structure and capable of obtaining a large transmission wavelength modulation can be realized by use of a photonic crystal 2.

According to the present invention, a highly-reliable and widely-applicable optical element capable of obtaining a large transmission wavelength modulation with an extremely simple and minute structure by use of a photonic crystal can be realized.

What is claimed is:

1. An optical element comprising:
a film-like optical waveguide formed with a piezoelectric material;
a photonic crystal structure arranged in an area inside said optical waveguide, in which a plurality of structural bodies formed with a material having a refractive index different from that of said optical waveguide is periodically arranged; and
a pair of control electrodes, which are provided at a part including at least said area of said optical waveguide, for applying a voltage to said optical waveguide,
wherein said pair of control electrodes is in an unfixed state at least in connection with its part corresponding to said area.

2. The optical element according to claim 1, wherein said control electrodes control a voltage applied to said optical waveguide to vary a periodic structure of said plurality of structural bodies of said photonic crystal structure, and thereby modulate and control a wavelength of the light inside said optical waveguide.

3. The optical element according to claim 1, wherein at least a part of the plurality of structural bodies of said photonic crystal structure is formed with a transparent resin as the material.

4. The optical element according to claim 1, wherein said optical waveguide is formed with a material selected from the group of:
(1-x)P (Mg_{1/3}Nb_{2/3})O₃-xPbTiO₃, (1-x)Pb(Zn_{1/3}Nb_{2/3})O₃-xPbTiO₃, and (1-x)Pb(Ni_{1/3}Nb_{2/3})O₃-xPbTiO₃, 0≦x≦1.

5. The optical element according to claim 1, wherein the part corresponding to the area has a structure free from restriction by a substrate.

6. The optical element according to claim 1, wherein both ends of the photonic crystal structure provided in the area are fixed by supporting parts.

7. A manufacturing method of an optical element, comprising the steps of:
forming an optical waveguide by laminating a clad layer, a core layer and a clad layer in this order on a substrate via a lower control electrode;
forming a photonic crystal structure, in which a plurality of structural bodies formed with a material having the refractive index different from that of said optical waveguide is periodically arranged in an area;
forming an upper control electrode on said photonic crystal structure; and
putting a part of said respective control electrodes corresponding to said area in an unfixed state.

8. The manufacturing method of an optical element according to claim 7, wherein said plurality of periodically arranged structural bodies is formed with a transparent resin material.

9. The manufacturing method of an optical element according to claim 7, wherein, in a step of putting the part corresponding to said area in said unfixed state, a part corresponding to at least said area of said substrate is removed by etching to put it in said unfixed state.
